(19) United States
(12) Patent Application Publication
(10) Pub. No.: US 2010/0142859 A1
(43) Pub. Date: Jun. 10, 2010

(54) RECLOSABLE FOOD PREPARATION BAG WITH INTEGRAL SHAKER HANDLES

(75) Inventor: Charles CUSHMAN, Marion, IL (US)

Correspondence Address: VEDDER PRICE P.C., 222 N. LASALLE STREET, CHICAGO, IL, 60601, US

(73) Assignee: COM-PAC INTERNATIONAL, INC., Carbondale, IL (US)

(21) Appl. No.: 12/332,088

(22) Filed: Dec. 10, 2008

(51) Int. Cl. B65D 33/08; B65D 33/16; B31B 1/00

(52) U.S. Cl. 383/10; 383/63; 493/267

(57) ABSTRACT

A re-closable food preparation bag made from a single sheet folded evenly at about half its length to form a first sheet fold and a second sheet fold, joined by two side seams and one bottom seam to form a bag main body, the bottom seam being offset a distance from the fold. The bag has a top handle cutout and a bottom handle cutout to form integral top and bottom handles. The bag also includes a re-closeable mechanism, including a first strip having at least a first locking rib being positioned on the first sheet fold's interior surface, a second strip having at least a second locking rib being positioned on the second sheet fold's interior surface in a position across from the first strip such that the at least first locking rib will interlock with the second locking rib to form a re-closeable seal

### FIELD OF THE DISCLOSURE

The present disclosure is related to a reclosable bag useful for marinating, brining or otherwise coating food with seasoning.

### BACKGROUND

Various methods are known for adding seasoning or flavor to foods prior to cooking, and such methods include the process of marinating and brining. The process of marinating involves steeping food in a marinade sauce which is a flavorful acidic liquid in which the food is soaked in order to add flavor and also tenderize it. The tenderizing effect is usually achieved by the acidity of the marinade sauce. Therefore, the basis of marinade sauce may include various acidic liquid such as vinegar, citrus juice, or soy sauce.

The process of brining on the other hand includes treating the food by steeping it in a solution of water and salt. The water and salt solution or “brine” may also include sweeteners such as but not limited to sugars, molasses, honey, corn syrup or any other suitable flavoring or sweetener. The salt in the brine when applied to meat has the effect of dissolving protein in the muscle and also reducing moisture loss during cooking. This results in the meat being juicier, more tender and having an improved flavor.

Another cooking method involves simply coating the meat with a, for example, breadcrumb based coating including various seasonings. This well-known method is often used for preparing chicken wherein the chicken may be coated with breadcrumbs, shredded cheeses and various spices.

All of the above food preparation processes, marinating, brining and food coating are typically performed using a plastic bag. Such bags are typically designed for food storage and therefore do not lend themselves well to the various processes such as shaking the bag to ensure that the marinade brine or seasoning coating is evenly distributed within the bag and thus evenly distributed onto the food such as meat or vegetables.

Therefore, what is needed is a bag that lends itself to the various food preparation processes such as marinating, brining or coating.

### BRIEF DESCRIPTION OF THE DRAWINGS

FIG. 1 is a view of an open food preparation bag in accordance with one embodiment.

FIG. 2 is a front view of a food preparation bag in accordance with the embodiment illustrated in FIG. 1.

FIG. 3 is a view of a food preparation bag in accordance with the embodiment illustrated in FIG. 1 and FIG. 2, prior to completion of assembly and showing the interior surface of the sheet forming the main body.

FIG. 4 is a view of the bottom handle of the food preparation bag, and illustrates how the sheet is folded to form the bag main body in accordance with the embodiment illustrate d in FIG. 1, FIG. 2 and FIG. 3.

FIG. 5 is a cross-sectional view of the bag shown in FIG. 1.

FIG. 6 is a flow chart illustrating a method of making a food preparation bag in accordance with the embodiment illustrated in FIGS. 1 through 5.

FIG. 7 is a view of the bottom handle portion in accordance with an embodiment wherein the bag main body is constructed using two separate sheets.

FIG. 8 is a cross-sectional view of the bag illustrated in FIG. 7.

FIG. 9 is a cross-sectional of a different embodiment of the bag illustrated in FIG. 7 and FIG. 8, wherein an additional bottom seam is used to add rigidity to the bottom handle.

FIG. 10 is a front view of a food preparation bag in accordance with another embodiment, wherein the bag is constructed from two separate sheets, and wherein one sheet has a patch type re-closeable seal.

FIG. 11 is a flow chart illustrating a method of making a food preparation bag in accordance with the various embodiments illustrated in FIGS. 7 through 10, wherein the bag is constructed of two separate sheets.

FIG. 12 is a flow chart illustrating a method of making a food preparation bag in accordance with the embodiment illustrated in FIG. 10.

### DETAILED DESCRIPTION

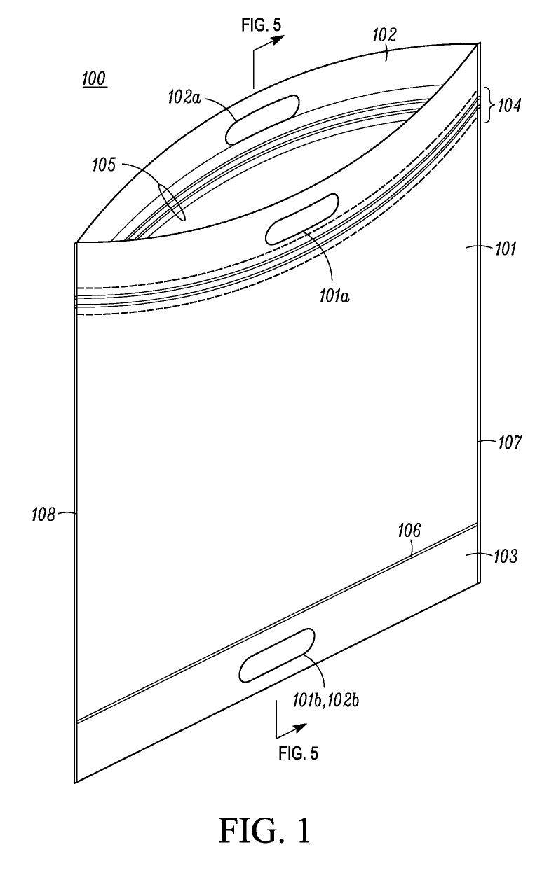

FIG. 1 provides a perspective view of a food preparation bag 100 in accordance with the embodiments disclosed herein. In the perspective view provided in FIG. 1 the bag 100 is shown in an open position. In one embodiment, the bag 100 comprises a main plastic sheet which is folded into two approximate sheet halves, at about the main plastic sheet center line, to form the bag main body. The main plastic sheet is folded about the centerline, but need not be on the exact centerline. A first plastic sheet fold 101 and a second plastic sheet fold 102 are connected and sealed by seams around the perimeters, specifically seams 106, 107 and 108. The bottom seam 106 also defines a bottom handle portion 103. The bottom handle portion 103 is formed by the remainder of the main plastic sheet extended from the bottom seam 106 to the approximate center line at where the fold was made. The bottom plastic handle portion 103 includes handle cutouts, which may be formed by a die, that is, as die-cut handle cutouts 103a and 103b. An upper portion of the plastic sheets folds 101 and 102, which form the main body of bag 100, also include corresponding handle cutouts 101a and 102a, respectively. The interior surfaces of the plastic sheet folds 101 and 102 also include a re-closeable mechanism that includes strips 104 and 105, respectively.

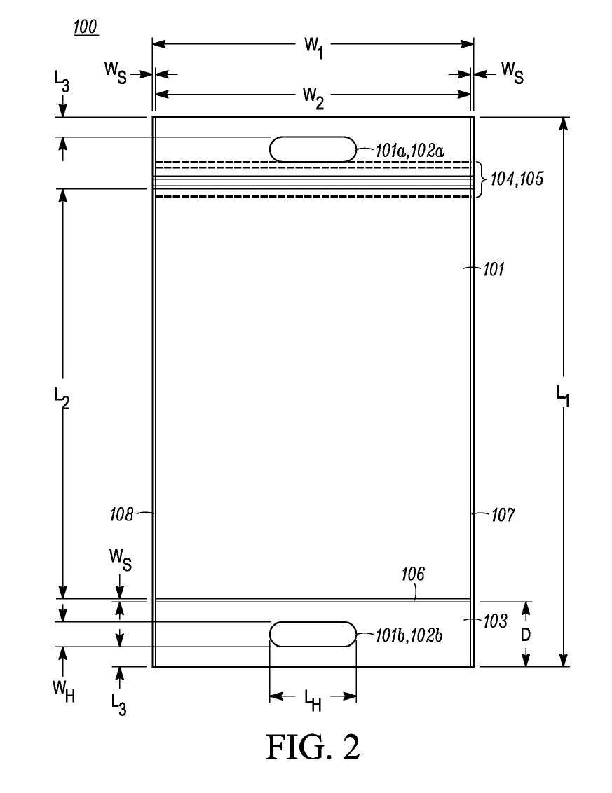

FIG. 2 illustrates a top view of the bag 100 of the embodiment illustrated in FIG. 1, laying flat, for example, as would be seen laying flat upon a countertop. The two plastic sheet folds 101 and 102, when folded as shown in FIG. 2, have an overall length L1, and an overall width W1. The length L2, which is taken from a lower locking rib to the top of bottom seam 106, by the width W2, which is taken as the internal distance between the internal side of seams 107 and 108, define the main body of the bag 100. The re-closeable mechanism formed by strips 104 and 105, as can be seen in FIG. 2, overlap such that at least two locking ribs may interlock to seal the bag 100 main body.

The seams 107 and 108, and bottom seam 106, have a seam width Ws. The handle cutouts 101a, 102a, 101b and 102b, have a handle length Lh and a handle width Wh. The outermost portion of the handle cutouts are positioned a length L3 from the top portion of the bag for 101a and 102a, and from the bottom fold of the bag for 101b and 102b. The distance between the bottom handle 103 bottom fold and the bottom of bottom seam 106 is a distance D. In other words, D is the length of the bottom handle portion 103, which has an overall width W1, which is equal to the bag 100 overall width.

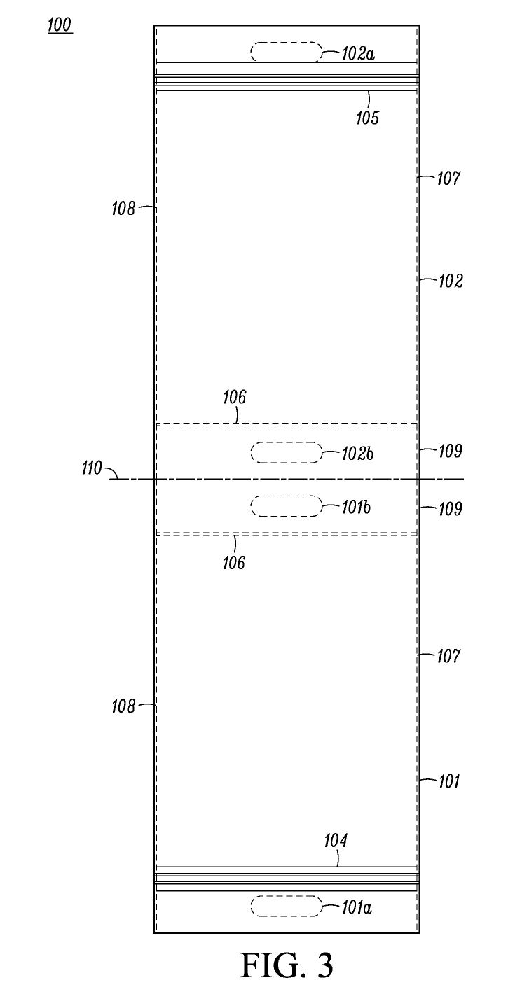

FIG. 3 provides further details of the bag 100. FIG. 3 shows the main plastic sheet 109 prior to folding along the approximate centerline 110, and prior to adding the seams 107, 108 and 109. The approximate centerline 110 may be within an inch of the actual centerline in either direction. Any other dimensions provided herein, whether specific or relative, are exemplary only and are also approximate in that they may be within a tolerance of plus and minus ¼ inch for dimensions ¼ inch or greater and 1/16 inch for dimensions less than ¼ inch. The handle cutouts 101a and 102a, which form the top handle, and the handle cutouts 101b and 102b which form the bottom handle, may be cutout prior to folding the main plastic sheet 109, or subsequent to folding the main plastic sheet 109. For most embodiments, the handle cutouts will be made subsequent to folding the main plastic sheet 109, such that only two cutouts may be performed, and to ensure that the top and bottom handle portions coincide, respectively. The handle cutouts may be performed using a die such that two die-cutouts may be made after folding to form the top and bottom handles.

In an alternative embodiment, instead of being formed from the main plastic sheet 109, the bag 100 may be formed from two separate plastic sheets such that the plastic sheets folds 101 and 102 would instead be separate plastic sheets 101 and 102. In this embodiment, an additional seam, which will be described further herein, may be provided at the bottom of the bag 100, that is, below bottom seam 106 and below the handle cutouts 101b and 102b which form the bottom handle 103, in order to provide additional rigidity to the bottom handle 103.

The two strips, 104 and 105, are added to the main plastic sheet 109, or to the two separate plastic sheets for the alternative embodiment discussed briefly above, in position approximately as shown FIG. 3, such that any locking ribs may interlock after the main plastic sheet 109 is folded and seamed with seams 106, 107 and 108. For example, the strip 104 may be positioned offset from the strip 105 such that the two ribs shown in FIG. 3 may be interlocked to seal the bag 100. Although two locking ribs per strip 104 and 105 are illustrated, some embodiment may include only a single locking rib per strip, or may include more than two locking ribs per strip. Any appropriate re-closeable mechanism that provides a liquid tight seal may be used and would remain in accordance with the embodiments herein described. Further, for example, the re-closeable mechanism may provide a seal that is an air tight seal as well as a liquid tight seal and would remain in accordance with the embodiments herein described.

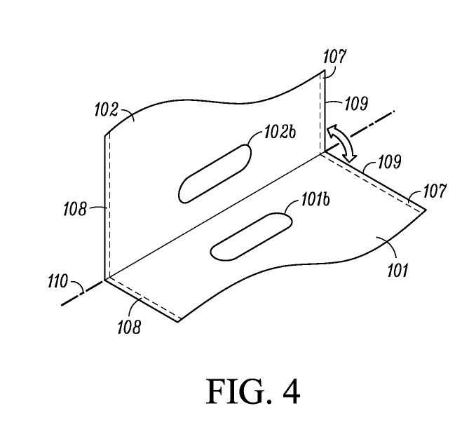

FIG. 4 illustrates how the main plastic sheet 109 of the bag 100 embodiment is folded to form first plastic sheet fold 101 and second plastic sheet fold 102. However, as discussed previously, the bag 100 may alternatively be formed from two separate plastic sheets, and in some embodiments, also include another bottom seam, below bottom seam 106, at the bottom of bottom handle 103.

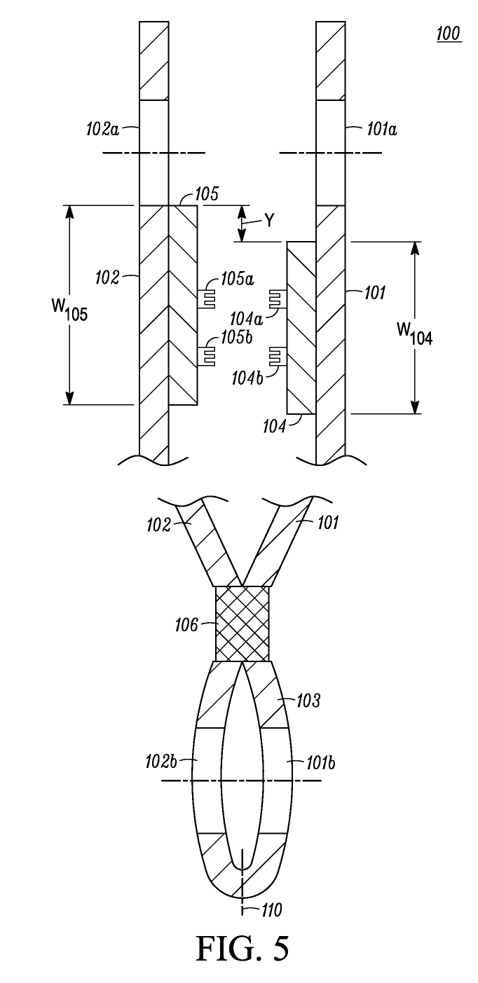

FIG. 5 provides a cross-sectional view of the bag 100 as illustrated in FIG. 1. In FIG. 5 the bag widths have been greatly exaggerated for the purpose of illustrating the details of the bag 100 structure. Therefore, it is to be understood that FIG. 5 is not to scale, and is only for the purpose of illustrating and describing features of the various embodiments. The re-closeable mechanism includes strips 104 and 105, which may be attached to plastic sheet folds 101 and 102, respectively, using an adhesive, heat sealing, or any other appropriate attachment process. The locking ribs 104a and 104b having respective mating locking ribs 105a and 105b, which interlock with applied pressure to seal the bag. The locking ribs may be what are sometimes referred to as a “zipper lock” ribs, but may be any suitable liquid tight locking ribs in accordance with the embodiments.

The strips 104 and 105 are attached to the plastic sheet folds 101 and 102, respectively, such that the locking rib portions may interlock, when pressure is applied by a user, so as to seal the bag 100 to prevent marinade or brine liquids from escaping. The rib portions may be pulled apart by applying a slight pulling force to subsequently open the bag 100. The strip 105 has a strip width W105, while the strip 104 has a strip width W104. The width W104 may be less than the width W105. The strip 104 may be positioned offset, by for example Y, from the strip 105 such that the locking ribs may appropriately interlock. Other embodiments may employ various other types of re-closeable mechanisms for maintaining a liquid tight, or air and liquid tight seal, as was discussed previously above.

The top handle cutouts 101a and 102a, in conjunction with the bottom handle cutouts 101b and 102b, form an integral bottom handle 103 integral to the bag 100 and provide a means for shaking the bag to evenly distribute marinade, brine or coating seasoning applied to meats or vegetables if desired. The bottom handle 103 is formed by the bottom seam 106 which seals the main body of the bag 100 and provides strength to keep the bag 100 sealed and in tact when shaken using the handled cutouts. The plastic sheet folds 101 and 102 are joined at the fold crease located at about the approximate centerline 110, which is shown exaggeratedly rounded in order to shown the construction. The seams, such as seam 106, are formed using sealing techniques as understood by those of ordinary skill. The plastic of the main plastic sheet 109, and thus of plastic sheet folds 101 and 102, as well as the strips and locking ribs, are food-grade plastic such that the plastic will not be leached by foods, marinades or brines that are either highly acidic or that contain alcohols, fats or any other chemical that may cause degradation of the plastic.

The bag 100 of the embodiments may come in various sizes. However, one specific embodiment will now be described with respect to FIG. 2. In one specific embodiment, the bag 100 may have a length L1 equal to approximately 22 inches and a width W1 of approximately 13 inches. The width of the bottom handle 103 D, that is, from the bottom to the first seam 106 to the bottom fold may be 2¾ inches. The seams 106, 107 and 108 around the perimeter of the bag may be ⅛ inch wide seams, that is, Ws is ⅛ inch. The handle cutouts 101a and 102a at the top of the bag 100, and the bottom handle cutouts 101b and 102b on the bottom handle portion 103 of the bag 100 may have a handle length Lh of 3½ inches and a handle width Wh of one inch. The handles may have arced ends. The handle cutouts may be positioned such that the distance of the top of the handles from the top of the bag 100 and the bottom fold, designated as L3 in FIG. 2, is at least one inches so as to provide adequate strength such that the bag 100 may be shaken without tearing the handles from the bag 100. The length designated L2 in FIG. 2 as the distance from the top of the bottom seam 106 to the first locking rib of strips 104 and 105, may be approximately 16½ inches and in conjunction with the width W2 of 12¾ inches, forms the containment volume of the bag 100. A second locking rib of the strips 104 and 105 may be spaced approximately ⅜ inches from the first locking rib.

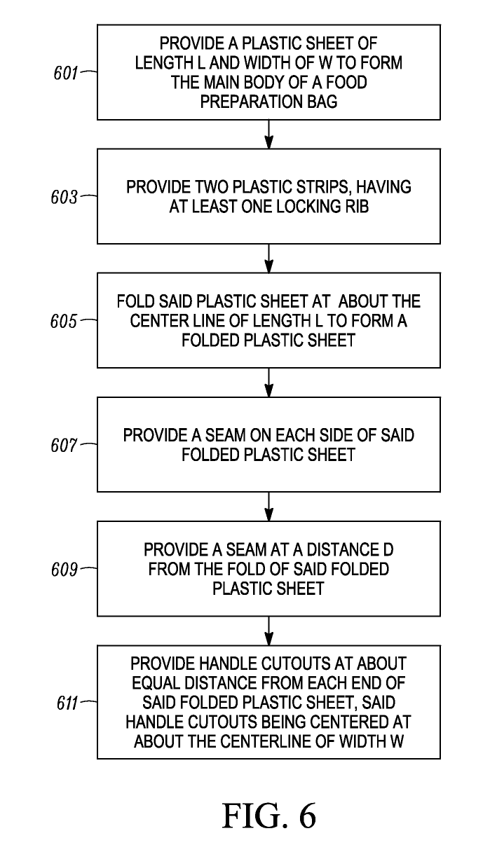

FIG. 6 is a flowchart illustrating a method of making a food preparation bag 100 in accordance with the embodiments. In 601, a plastic sheet having a length L and a width W is provided to form the main body of a food preparation bag. In 603, two plastic strips, each having at least one locking rib, are affixed near the top and bottom of the plastic sheet. In 605, the plastic sheet is folded at about the centerline, that is, at approximately L/2, to form a folded plastic sheet. A seam is provided on each side of the folded plastic sheet as shown in 607, and a bottom seam is added at a distance D from the fold as shown in 609. In 611, handle cutouts are provided at about equal distance from each end of the folded plastic sheet where the handle cutouts are at about the centerline of the main plastic sheet width W.

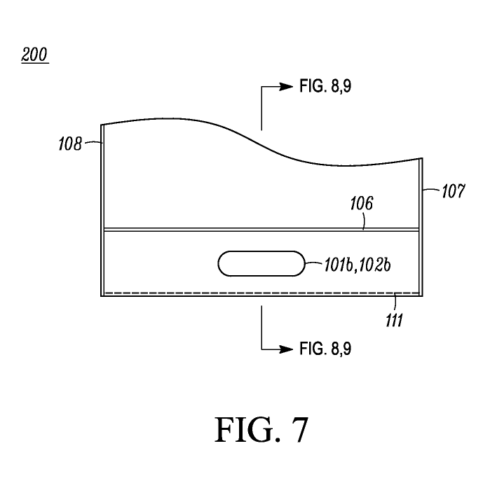

FIG. 7 is a view of the bottom handle portion of a bag 200 wherein the bag main body is constructed using two separate sheet as was discussed briefly above. The bottom handle may include an additional seam 111 for adding rigidity to the bottom handle.

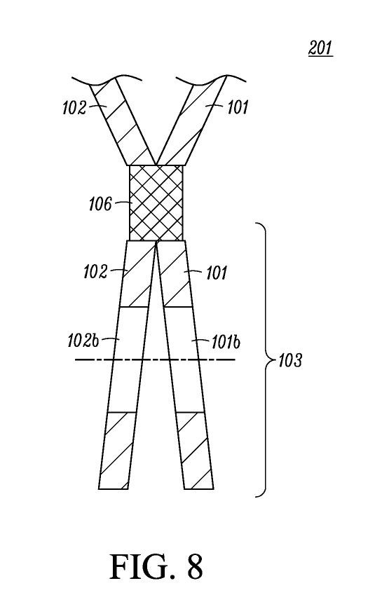

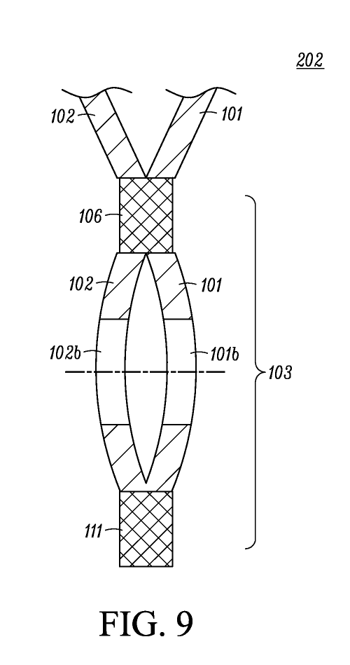

FIG. 8 and FIG. 9 are cross-sectional views of two alternative embodiments, bag 201 and bag 202, with respect to the bag 200 illustrated in FIG. 7. FIG. 8 illustrates a bag 201, which is an embodiment constructed of two separate plastic sheets 101 and 102. The bag 201 main body is sealed at the bottom by bottom seam 106. However, as shown in FIG. 8, the bottom handle portion 103 is not connected below the handle cutouts 101b and 102b. FIG. 9 illustrates a bag 202, which is an embodiment where the bottom is seamed by seam 111, which provides additional rigidity to the bottom handle portion 103, and provides additional strength against tearing the plastic while shaking the bag 202.

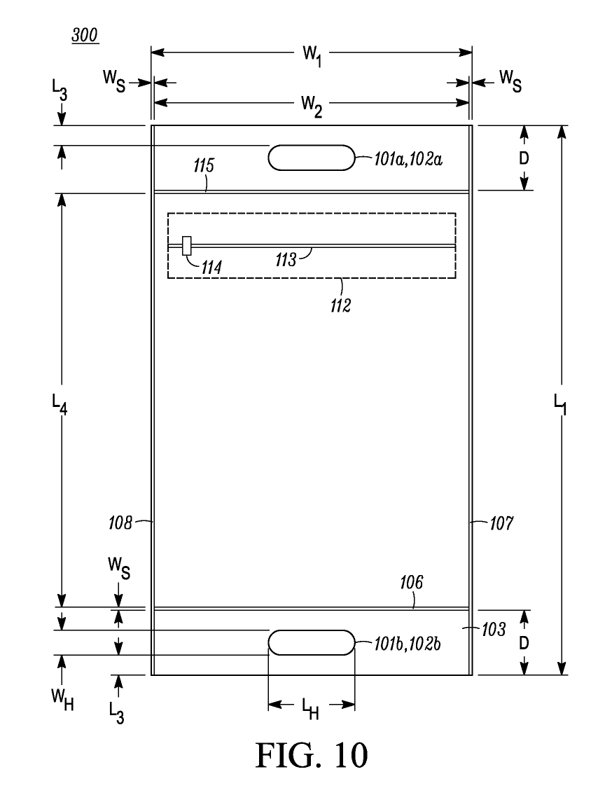

FIG. 10 is a front view of another embodiment of a food preparation bag, bag 300, wherein the bag may be constructed from two separate plastic sheets 101 and 102, and wherein one sheet has a patch type re-closeable seal 112. The patch type re-closeable seal 112 includes an aperture 113 and may have, for example, a slide-able tab 114 which is slide-able for opening and closing the bag 300 to form a liquid tight, or an air and liquid tight, seal. For the embodiment illustrated as bag 300, another seam 115, similar to bottom seam 106, is required to seal the two plastic sheets 101 and 102 at the top of the bag 300. The seam 115 also forms a top handle portion, having handle cutouts 101a and 102a, similar to the bottom handle portion 103.

For the bag 300, the top and bottom handle portions may be constructed in either of the manners illustrated in FIG. 8 or FIG. 9, that is, without a seam at the ends of the handle portions as shown in FIG. 8, or with a seam at the ends of the handle portions as shown in FIG. 9. Further, the bag 300 may be constructed of a single plastic sheet folded at one end, as was described above generally with respect to FIG. 1 through FIG. 5. In this embodiment, only the re-closeable mechanism would be different than that shown in, for example, FIG. 1, and an additional top seam would be required, such as seam 115 discussed above in FIG. 10, to completely seal the bag main body.

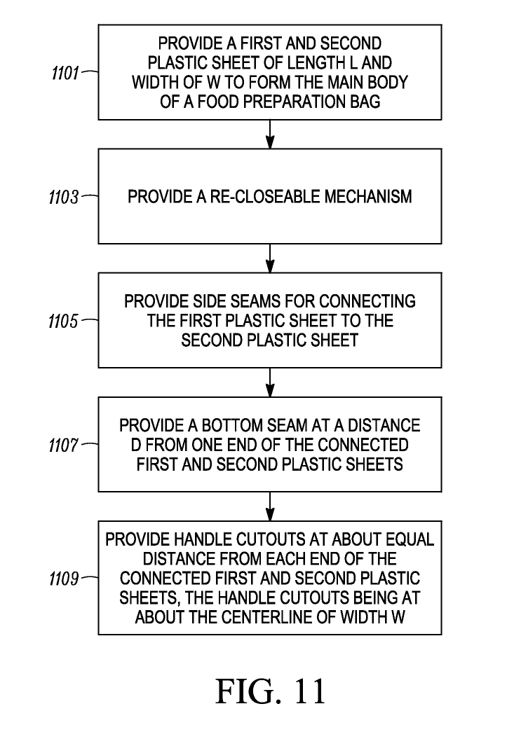

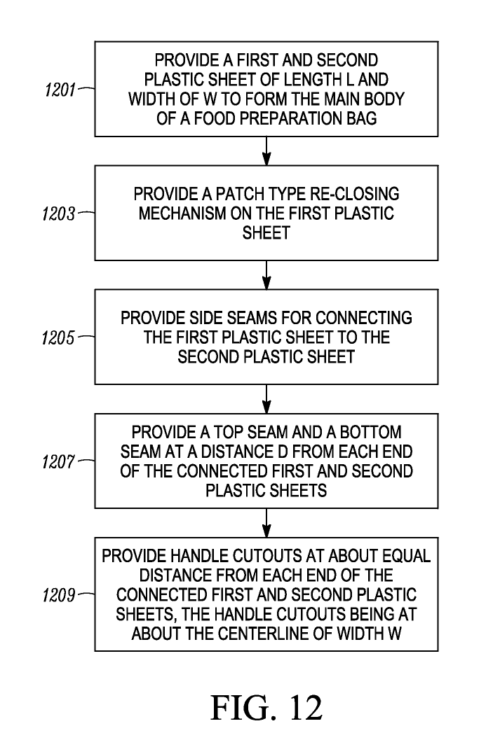

FIG. 11 and FIG. 12 are flow charts illustrating methods of making a food preparation bag in accordance with the various embodiments illustrated in FIGS. 7 through 10, wherein the bag is constructed of two separate sheets. Beginning with FIG. 11, in 1101, a first and second plastic sheet are provided to form the main body of a food preparation bag, such as, bag 100, bag 200, bag 201, bag 202, bag 300, or other alternative embodiments as may be contemplated in light of the description provided herein. In 1103, a re-closeable mechanism is provided. In 1105, side seams are added to connect the first plastic sheet to the second plastic sheet. In 1107, a bottom seam is added at a distance D from one end of the connected first and second plastic sheets. In 1109, handle cutouts are provided at about equal distances from each end of the connected first and second plastic sheets. The handle cutouts are approximately centered about the approximate centerline of the bag's width.

FIG. 12 illustrates a method of making a bag, such as bag 300 illustrated in FIG. 10. In 1201, a first and second plastic sheet are provided to form the bag 300 main body. In 1203, a patch type re-closing mechanism, for example, patch type re-closeable seal 112, is provided on the first plastic sheet. The patch type re-closing mechanism may be applied to the first plastic sheet using methods as understood by those of ordinary skill. In 1205, side seams are provided for connected the first plastic sheet to the second plastic sheet. In 1207, a top seam and a bottom seam are provided at a distance D from each end of the connected first and second plastic sheets. While D may be equal in some embodiments, other embodiments may have a top seam and a bottom seams at different distances from the respective top end and bottom end of the connected first and second plastic sheets. In 1209, handle cutouts are provided at about equal distances from each end of the connected first and second plastic sheets. The handle cutouts are at about the approximate centerline of the bag width.

Other variations that would be equivalent to the herein disclosed embodiments may occur to those of ordinary skill in the art and would remain in accordance with the spirit and scope of embodiments as defined herein by the following claims.

What is claimed is:

1. A reclosable bag for marinating, brining or seasoning food comprising:
a single sheet having a fold evenly, at about half its length, to form a first sheet fold with a first interior surface and a second sheet fold with a second interior surface, said first sheet fold and said second sheet fold joined by two side seams and a bottom seam to form a bag main body having an overall length and an overall width, said bottom seam being offset a distance from said fold;
a top handle cutout, and a bottom handle cutout, through said first sheet fold and said second sheet fold to form an integral top handle and an integral bottom handle, integral to said bag; and
a re-closeable mechanism, for providing a liquid tight seal.

2. The re-closeable bag of claim 1, wherein said re-closeable mechanism comprises:
a first strip having at least a first locking rib being positioned on said first interior surface, a second strip having at least a second locking rib being positioned on said second interior surface, in a position across from said first strip, such that said at least first locking rib will interlock with said second locking rib to form a re-closeable seal of said bag.

3. The re-closable bag of claim 2, wherein said first strip further comprises a third locking rib and said second strip further comprises a fourth locking rib, wherein said third locking rib is aligned to interlock with said fourth locking rib.

4. The re-closeable bag of claim 2, wherein said first strip's top length is aligned with the bottom of said top handle cutout and wherein said second strip's top length is aligned at an offset below said bottom of said top handle cutout, such that said at least first locking rib is aligned to interlock with said at least second interlocking rib.

5. The re-closeable bag of claim 1, further comprising:
a top seam positioned below said top handle cutout; and
a patch-type re-closeable seal forming said re-closable mechanism, said patch-type re-closeable seal installed on one of either said first interior surface or said second interior surface and including an aperture through said first interior surface or said second interior surface to allow for food or liquid to be placed into said bag.

6. The re-closable bag of claim 1, wherein said top handle cutout's top is positioned a distance from an end of said overall length opposite to said fold of said bag main body and said bottom handle cutout is positioned an equal distance from said fold, thereby forming an integral top handle and an integral bottom handle at opposite ends of said bag main body.

7. The re-closeable bag of claim 6, wherein said distance equals at least one inch.

8. The re-closeable bag of claim 1, wherein said side seams and said bottom seam are approximately ⅛ inch wide seams.

9. The re-closeable bag of claim 1, wherein said overall length is approximately 22¼ inches and said overall width is approximately 13 inches.

10. The re-closeable bag of claim 1, wherein said top handle cutout and said bottom handle cutout are both one inch wide by 3½ inches long and have arced ends.

11. The re-closeable bag of claim 9, wherein said top handle cutout and said bottom handle cutouts are positioned lengthwise centered about a centerline of said overall width of said bag main body.

12. The re-closable bag of claim 1, wherein said single sheet is a food grade plastic.

13. A re-closeable bag for marinating, brining or seasoning food comprising:
a first sheet having a first interior surface and a second sheet having a second interior surface, said first sheet and said second sheet joined by two side seams and a bottom seam to form a bag main body having an overall length and an overall width, said bottom seam being offset a distance from a lengthwise end of said first and second sheets; a top handle cutout, and a bottom handle cutout, through said first sheet and said second sheet to form an integral top handle and an integral bottom handle, integral to said bag, wherein said top handle cutout and said bottom handle cutouts are positioned lengthwise centered about a centerline of said overall width of said bag main body; and
a re-closeable mechanism, for providing a liquid tight seal.

14. The re-closeable bag of claim 13, wherein said re-closeable mechanism comprises:
a first strip having a first set of locking ribs being positioned on said first interior surface, a second strip having a second set of locking ribs being positioned on said second interior surface, in a position across from said first strip, such that said first set of locking ribs will interlock with said second set of locking ribs to form a re-closeable seal of said bag.

15. The re-closable bag of claim 14, wherein said first strip further comprises a third locking rib and said second strip further comprises a fourth locking rib, wherein said third locking rib is aligned to interlock with said fourth locking rib.

16. The re-closeable bag of claim 14, wherein said first strip's top length is aligned with the bottom of said top handle cutout and wherein said second strip's top length is aligned at an offset below said bottom of said top handle cutout, such that said at least first locking rib is aligned to interlock with said at least second interlocking rib.

17. The re-closeable bag of claim 13, further comprising:
a top seam positioned below said top handle cutout; and
a patch-type re-closeable seal forming said re-closable mechanism, said patch-type re-closeable seal installed on one of either said first interior surface or said second interior surface and including an aperture through said first interior surface or said second interior surface to allow for food or liquid to be placed into said bag.

18. The re-closable bag of claim 13, wherein said top handle cutout's top is positioned a distance from an end of said overall length of said bag main body and said bottom handle cutout is positioned an equal distance from an opposite end, thereby forming an integral top handle and an integral bottom handle at opposite ends of said main body.

19. The re-closeable bag of claim 18, wherein said distance equals at least one inch.

20. The re-closeable bag of claim 13, wherein said side seams and said bottom seam are approximately ⅛ inch wide seams.

21. The re-closeable bag of claim 20, wherein said overall length is approximately 22¼ inches and said overall width is approximately 13 inches.

22. The re-closeable bag of claim 20, wherein said top handle cutout and said bottom handle cutout are both one inch wide by 3½ inches long and have arced ends.

23. The re-closable bag of claim 13, wherein said first sheet and said second sheet are a food grade plastic.

24. A method of making a food preparation bag comprising:
providing a sheet having a length L and a width W, to form said food preparation bag;
providing a re-closeable mechanism for providing a liquid tight seal;
folding said sheet at about a centerline of approximately half said sheet's length, to form a folded sheet having a bottom fold, said folded sheet having an overall length and an overall width and forming a main body of said bag;
providing a seam on each side of said folded sheet, and providing a bottom seam at a distance D from said bottom fold; and
providing handle cutouts at about equal distance from each end of said folded sheet.

25. The method of claim 24, wherein providing a re-closeable mechanism for providing a liquid tight seal, comprises:
providing two plastic strips, each having at least one locking rib, and affixing said two plastic strips near the top and bottom of said sheet.

26. The method of claim 24, further comprising:
providing a top seam positioned below said top handle cutout; and
wherein providing a re-closeable mechanism for providing a liquid tight seal, comprises:
providing a patch-type re-closeable seal forming said re-closable mechanism, said patch-type re-closeable seal installed on one of either said first interior surface or said second interior surface and including an aperture through said first interior surface or said second interior surface to allow for food or liquid to be placed into said bag.

27. The method of claim 24, wherein providing handle cutouts further comprises:
providing a top handle cutout and a bottom handle cutout, each positioned lengthwise centered about a centerline of said overall width, said top handle cutout 's top being positioned at a distance away from said folded sheet top, equal to a distance of said bottom handle cutout's bottom from said fold.

28. The method of claim 27, wherein providing a bottom seam further comprises:
providing a bottom seam at approximately 2¾ inches away from said fold.

29. A method of making a food preparation bag comprising:
providing a first sheet having a first interior surface and a second sheet having a second interior surface, said first sheet and said second sheet having a length L and a width W, to form said food preparation bag;
providing a re-closeable mechanism for providing a liquid tight seal;
providing a seam joining said first sheet to said second sheet on each lengthwise side, and providing a bottom seam widthwise at a distance D from one lengthwise end of said first sheet and said second sheet; and
providing handle cutouts at about equal distance from each end lengthwise of said first sheet and said second sheet.

30. The method of claim 29, wherein providing a re-closeable mechanism for providing a liquid tight seal, comprises:
providing two plastic strips, each having at least one locking rib, and affixing said two plastic strips near the lengthwise adjoining ends of said first sheet and said second sheet.

31. The method of claim 29, further comprising:
providing a top seam positioned below said top handle cutout; and
wherein providing a re-closeable mechanism for providing a liquid tight seal, comprises:
providing a patch-type re-closeable seal forming said re-closable mechanism, said patch-type re-closeable seal installed on one of either said first interior surface or said second interior surface and including an aperture through said first interior surface or said second interior surface to allow for food or liquid to be placed into said bag.

32. The method of claim 31, wherein providing a bottom seam further comprises:
providing a bottom seam at approximately 2¾ inches away from a bottom end lengthwise of said first sheet and said second sheet; and
wherein providing a top seam positioned below said top handle cutout further comprises:
providing a top seam position approximately 2¾ inches away from a top end lengthwise of said first sheet and said second sheet.
